(19) United States
(12) Patent Application Publication
(10) Pub. No.: US 2012/0179847 A1
(43) Pub. Date: Jul. 12, 2012

(54) Method and System for Implementing Bus Operations with Precise Timing

(75) Inventor: ALAN BERENBAUM, NEW YORK, NY (US)

(73) Assignee: STANDARD MICROSYSTEMS CORPORATION, HAUPPAUGE, NY (US)

(21) Appl. No.: 13/004,890

(22) Filed: Jan. 12, 2011

(51) Int. Cl. G06F 13/36

(52) U.S. Cl. 710/107

(57) ABSTRACT

The present disclosure describes a system and method for implementing bus operations with precise timing. The system includes a trigger descriptor register for a bus operation. The trigger descriptor register includes a bus definition field, which further includes data and address fields for providing data and address information for the bus operation. The trigger descriptor register may also include a holdoff time field to store a time value and includes an event select field to select a trigger for the bus operation. A processor configures the trigger descriptor register. A counter may count based on a time period such that at the end of the counting, the bus operation is performed based on the data and address fields. The time period is derived from one or more of the holdoff field or an external timer. The disclosed method and system employ hardware assist for maintaining precise timing while performing bus operations.

### BACKGROUND

This application deals generally with the field of embedded systems, and more specifically with bus operations (register and memory reads and writes) within an embedded system.

In an embedded controller system, requirements may mandate that some actions occur in response to events. Some of the requirements are real-time; that is, the response must occur at a well-defined time after the initial event.

Another common function that embedded controllers support is exchange of information with one or more devices through communication. Protocols are generally well defined in terms of pulse edges, and a small amount of jitter is permitted. Many communication protocols, such as Philip's I2C, are directly supported in hardware. An embedded controller, however, may be required to support a protocol that was not anticipated when designing the hardware. One technique for addressing this problem is referred to as “bit-banging,” in which the controller directly toggles pins for each transmitted bit or byte.

The classical solution for handling events that were not known at the time a device was designed employs an embedded controller (or a processor). The processor, following a program (part of the device firmware), can examine inputs and determine how to respond to a changing stimulus input or event. This approach is very flexible, especially if the firmware for the embedded controller can be modified. A number of limitations exist, however, as described below.

In general, a processor is capable of performing varied and complex operations on input and output signals, but these capabilities come at a cost. If the response must be timely, the processor will likely require an interrupt that directs its attention to an event. Such interrupts can consume considerable time, and consequently the processor response may occur too. In addition, processing interrupts can require many processor cycles, which means that the processor cannot be working on other functions while it is responding to the event. Another limitation is that using a processor to perform a simple response can require considerable power, as the processor may require thousands of gates, in addition to instruction and data memory, to process the instructions required for the response.

Further, implementing a communication protocol using “bit-banging” may be unsatisfactory for several reasons. The processor may not be fast enough to toggle bits at the required rate, or it may lack sufficient capacity to do so while performing other required tasks. Because the load on the processor may vary over time, it can be difficult, if not impossible, for firmware to maintain precise timing relationships between bits and bytes of the communication protocol, thereby making the implementation non-compliant with the protocol requirements.

### SUMMARY

The present disclosure describes a system for implementing bus operations with precise timing. The system includes a trigger descriptor register for describing a bus operation. The trigger descriptor register includes a bus definition field, which further includes data and address fields for providing data and address information for the bus operation. The trigger descriptor register also includes an event select field to select a trigger for the bus operation. A processor is capable of configuring the trigger descriptor registers.

Another embodiment of the present disclosure a method for implementing bus operations with precise timing. The method involves providing a trigger descriptor register including a bus definition field, which further includes data and address fields. The trigger descriptor register also includes an event select field for selecting a trigger for the bus operation. The method selects a trigger for the bus operation based on the event select field. Then, the method performs the bus operation based on the address and data fields.

### BRIEF DESCRIPTION OF THE DRAWINGS

The drawings described below set out and illustrate a number of exemplary embodiments of the disclosure. Throughout the drawings, like reference numerals refer to identical or functionally similar elements. The drawings are illustrative in nature and are not drawn to scale.

FIG. 1 illustrates a system for implementing bus operations with precise timing.

FIG. 2 depicts a method for implementing bus operations with precise timing within the system of FIG. 1.

### DETAILED DESCRIPTION

The following detailed description is made with reference to the figures. Exemplary embodiments are described to illustrate the subject matter of the disclosure, not to limit its scope, which is defined by the appended claims.

### Overview

Hardware is usually designed for a specific set of functions. Thus, hardware is not flexible and generally cannot be extended to other functions without physical changes. The disclosed methods and systems enable hardware-assisted implementation of protocols, even if those protocols were not anticipated when building the hardware. The described exemplary system provides a set of triggers that can perform reads and writes based on an event, precluding processor intervention. Here, both performance uncertainties and execution time can be reduced, because the interrupt is serviced by hardware. Some embodiments of the present disclosure are especially suitable for servicing interrupts that involve a small amount of work or terminate such as triggering a few write operations. Further, the embodiments of the present disclosure allow sequencing of events, such as first allowing a signal to occur and then performing a function a defined time later.

### Specific Description Sections

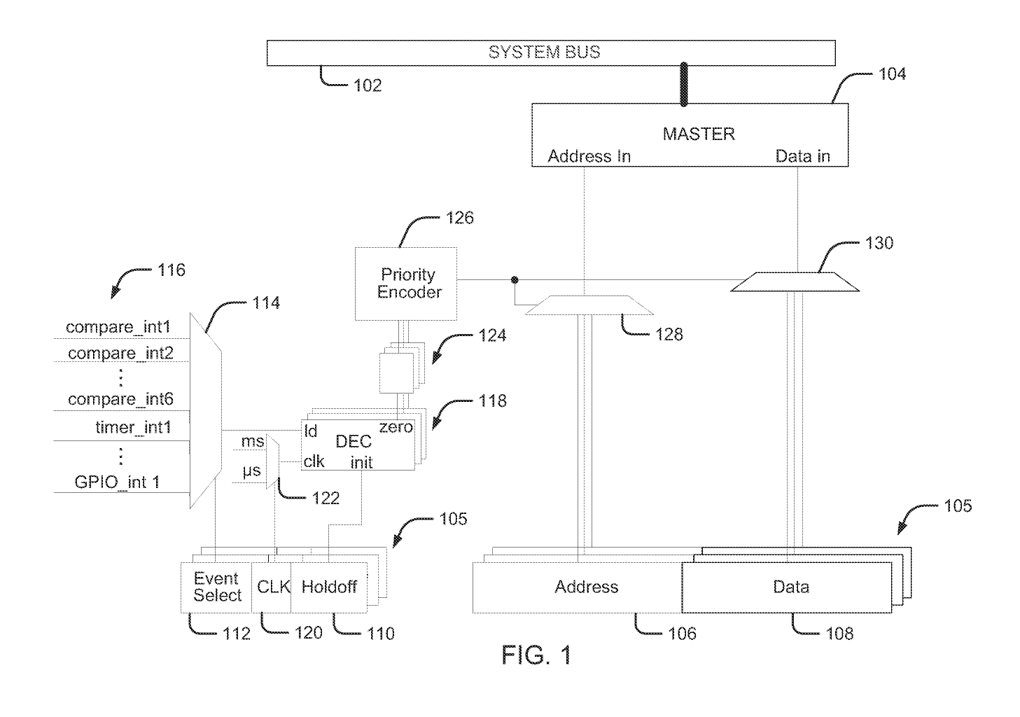

FIG. 1 illustrates a system 100 for implementing bus operations with precise timing. The system 100 is capable of performing a bus transaction (read or write) over an internal system bus 102, such as an Advanced High-performance Bus (AHB). Each of these transactions may be triggered by an interrupt signal, provided by a suitable source, such as a timer. The interrupt itself can be masked so that even if an embedded controller or processor ignores the interrupt, the triggered bus operation will still occur. The bus operation also may be triggered by a software write, as explained in more detail below.

The system 100 includes a master interface 104 (such as an AHB master interface) and a set of trigger descriptor registers 105 that define bus operations. The AHB master may also provide sequencing. Each trigger descriptor register 105 includes an address field 106 and a data field 108. An event select field 112 points to one or more interrupt signals that can trigger the bus operation. Several interrupt signals may be logically combined by OR-ing or AND-ing the interrupt. Additionally, a holdoff time field 110 may be provided, to indicate the length of a time period.

Further, a trigger descriptor register 105 may include fields indicating whether a bus operation is a read or write, the number of bytes to be read or written, or whether I/O is enabled. Also, a condition field may be included, indicating whether the embedded controller is in a sleep state, in a low power state, or whether an external bus is active. Based on the condition field, a trigger may be activated.

The event select field 112 acts as a selector for a multiplexer 114. That device accepts input signals, such as interrupt signals 116, such as a compare timer signal, other timer signals, or a General Purpose Input/Output (GPIO) interrupt. The event select field 112 selects a signal (trigger) from the interrupt signals 116 for the bus operation. In one implementation, the trigger could originate from any one of a number of triggers. For example, the event select field 112 in the trigger descriptor register 105 can be a bit vector corresponding to all possible triggers, rather than a short bit field that encodes exactly one trigger. That structure may be advantageous for glue logic, where an output is asserted either in response to an external input or after a delay from another event, whichever comes first.

For providing the required time period and sequencing, the holdoff time field 110 provides an alternative to external timers such as a compare timer. The holdoff period loaded into a counter acts a timer for sequencing. This holdoff time can be much shorter than similar holdoffs stored in an external timer because the signal need not be routed to the interrupt logic. That structure facilitates precise timing during the bus operations. FIG. 1 demonstrates how the holdoff time field 110 can initialize a decrementing counter, which can, for example, count down to zero based on the time indicated in the holdoff time field 110. After the countdown, the bus operation is triggered based on the interrupt signal 116 loaded into the decrementing counter. In FIG. 1, the trigger descriptor register 105 includes a clock field 120 that serves as a selector for a multiplexer 122, allowing selection of a time unit, generally denominated as milliseconds or microseconds. A decrementing counter 118 utilizes the selected time unit. It will be understood by those in the art that although a decrementing counter is described here, any type of counter may be used to perform the count down of the time period.

A priority encoder 126 may be included to sequence bus operations based on a token number provided to each bus operation. Alternatively, priority information may be related to each bus operation. Those skilled in the art will understand, however, that priority maybe provided to bus operations in a queue based on several known techniques.

FIG. 1 shows that the output of the priority encoder 126 acts as the selector for two multiplexers—an address multiplexer 128 and a data multiplexer 130. In that manner, the system selects appropriate address information and data for performing the bus operation. The address and data information is provided to the master interface 104, which then performs the bus operation over the system bus 102.

It should be understood that the system 100 is exemplary in nature and several variations can be contemplated without departing from the scope or purpose of the claimed invention. For instance, instead of the multiplexer 114 for selection of a trigger, a level of indirection, such as the event select field 112 identifying an address for the trigger may be utilized. Further, it should be understood that the fields described here may also vary in nature and size.

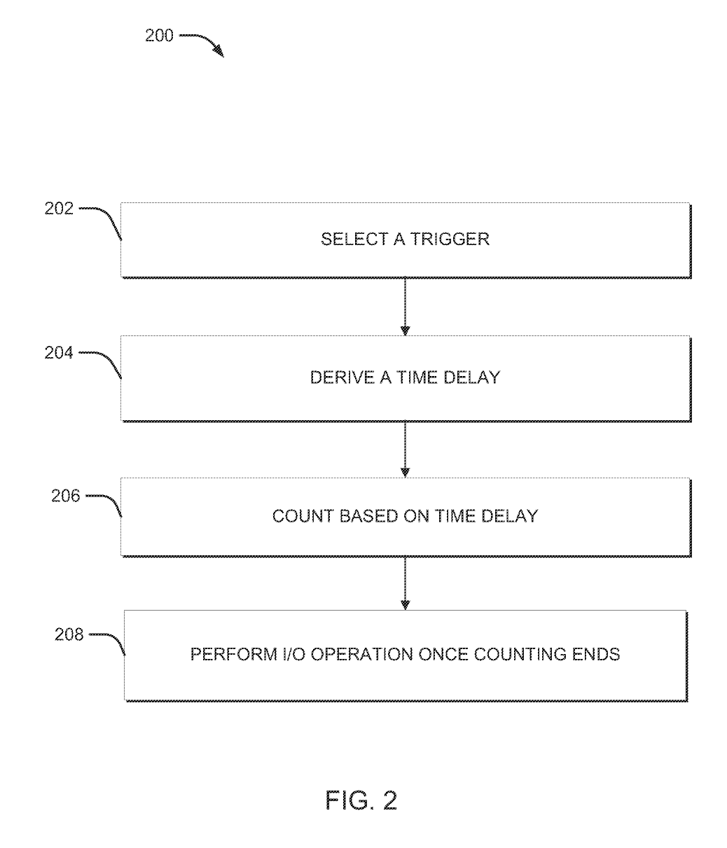

FIG. 2 depicts a method 200 for implementing bus operations with precise timing within the system 100. It should be noted that before the method 200 begins, the processor or embedded controller configures the trigger descriptor registers 105.

At step 202, the event select field 112 selects a trigger, such as interrupt signal 116. Based on the holdoff time field 110 or an external timer, a time period is derived at step 204. This trigger can activate the related trigger descriptor register 105 after the derived time period. The decrementing counter 118 counts down based on the time period at step 206. Once the counting ends, the bus operation related to the trigger descriptor register 105 is performed at step 208. The hardware selects the appropriate address and data while performing the bus operation.

Consider an example of how the method 200 may execute. A condition could be imposed, for example, that if a pin on the particular chip goes low, a second selected pin should follow 10 ms later. To accomplish that result, the event select field 112 is configured to select a GPIO interrupt. The GPIO is configured such that when the pin has a high to low transition, the GPIO signal (one of the interrupt signals 116) goes high. Additionally, the clock field 120 is configured to select milliseconds as the time unit, the holdoff time field 110 contains ‘10’, the address field 106 includes the address of the GPIO control register output pin, and the data field 108 contains ‘0’. Thus, when GPIO 0 triggers, the event select field 112 selects GPIO 1, loads 10 from the holdoff time field 110 into decrementing counter 118 and selects milliseconds as the clock unit. After a delay of 10 ms, the bus operation is performed. The system 100 performs a write operation to the GPIO control register, changing the state of the output pin.

By using the interrupt signal 116 derived from an external input pin, a write can be configured to occur a precise programmed period of time after an external event. Other interrupts could be used as well. For example, a system could base actions on an event from a controller such as I2C, or on an over-temperature event detected in a temperature monitor, or upon an analog compare circuit detecting a selected voltage level. These and other possible scenarios will be apparent to those of skill in the art.

In another example, the event select field 112 may select a different one of the interrupt signals 116, such as the compare timer. In general, the compare timer utilizes the global clock. Assume a requirement that a bus operation must be performed over a serial peripheral interface (SPI) port after a timer has counted two seconds. Here, the address field 106 points to the SPI port, and the data field 108 carries an enable bit to enable the SPI to start transmitting. Because the time period is being derived from the compare timer, the holdoff time field 110 contains ‘0.’ The event select field 112 is configured to select compare timer 1, and the compare timer is configured to count up to 2 seconds. After 2 seconds, the bus operation is enabled at the SPI port.

As discussed, if more than one bus operation is triggered, then the priority encoder 126 sequences among the bus operations. The sequencing can occur in numerical order, with lower-numbered events having priority over higher-numbered ones. Alternatively, the holdoff time can be pre-scaled based on the clock field 120 and the multiplexer 122. That condifuaration permits time units in microseconds or milliseconds, as desired. It should be noted that the units specified here are exemplary in nature and any time unit preferred may be employed.

Using the holdoff time field 110, one compare timer interrupt may trigger two events, one with a zero delay and the second with a non-zero delay. This mechanism can be used to generate a pulse if both bus operations write to the same GPIO data register. This mechanism can also sequence two external signals. Moreover, this mechanism can also configure some other hardware logical device by first writing the device configuration register, then enabling the device by writing another register, for example. Proper sequencing can be maintained by setting the holdoff time field 110 to increasing values for each sequential bus operation.

An example of this mechanism is as follows. To begin an SPI operation, a direct memory access (DMA) controller and a SPI controller are enabled, which involves two writes to two different registers. Two trigger descriptor registers 105 are configured, and they trigger on a compare timer signal, which fires 2 seconds in the future. The first trigger descriptor register 105 has a holdoff time of 0 ms while the second has a holdoff time of 1 ms. The first trigger descriptor register 105 triggers, and then the priority encoder 126 queues the bus operation. Then, the second trigger descriptor register 105 is activated. Sequencing is performed by the holdoff times while the priority encoder 126 may be utilized to queue the bus operations. Thus, several bus operations can be triggered based on same event, and proper sequencing is guaranteed.

An alternative mechanism for triggering bus operations is using software. Software can perform a write operation to a trigger descriptor register, obviating the need for a compare timer or a pin interrupt. When combined with the holdoff timers within each trigger descriptor register 105, software can set off a precisely-timed sequence of events by a single write to a control register. One application of such software writes is described below.

The actions defined by the trigger descriptor registers 105 are performed once, after which the trigger descriptor register is deactivated. Software can, however, extend the functionality to multiple-time execution. Here, the method 200 can involve both a software-triggered event and a hardware-triggered event, where the software can decide whether the hardware event should repeat. Glue logic is one example where this extended functionality may be employed. Consider a situation in which, if a first pin goes low in response to a first event, a second event occurs, which could be a second pin likewise going low, 50 ms later. Once the first event occurs, software may sense that the second event has already occurred on the second pin. Here, the software can decide whether the second event should be re-enabled.

Consider another example. A transmission of 16 bits requires 32 signal transitions. Applying the extended functionality discussed above, the method 200 will not require 32 trigger descriptor registers 105, but rather it can manage with fewer registers by updating the trigger descriptor registers 105 by software. A sequence of trigger descriptor registers 105 can be configured, and the transmission can be carried out using only eight trigger descriptor registers 105. A first set of four trigger descriptor registers 105 is activated to start transmitting data based on a first event. A second set of four trigger descriptor registers 105 is activated on a second event. One of the first four trigger descriptor registers 105 can set up a timer, which can provide an interrupt to the embedded controller on completion. The embedded controller receives the interrupt, indicating that data transmission by the first set is complete. The software then re-configures the first set of trigger descriptor registers 105 for further data transmission. Here, software has enough time to update the first set. In this manner, any amount of data may be transmitted using only few trigger descriptor registers 105. The hardware mechanism can be extended through software while maintaining the precision of hardware.

Those in the art will understand that the steps set out in the discussion above may be combined or altered in specific adaptations of the disclosure. The illustrated steps are set out to explain the embodiment shown, and it should be anticipated that ongoing technological development will change the manner in which particular functions are performed. These depictions do not limit the scope of the present disclosure, which is determined solely by reference to the appended claims.

We claim:

1) A system for implementing bus operations with precise timing, the system comprising:
a trigger descriptor register for describing a bus operation, the trigger descriptor register including:
a bus definition field further including data and address fields, configured for providing data and address information for the bus operation; and
an event select field configured to select a trigger for the bus operation; and
a processor for configuring the trigger descriptor register.

2) The system of claim 1, wherein the trigger descriptor further includes a holdoff time field configured to store a time value.

3) The system of claim 2 further comprising a counter configured to count based on a time period, wherein at the end of the counting, the bus operation is performed based on the data and address fields, the time period being derived from one or more of:
the holdoff field; or
an external timer.

4) The system of claim 1, wherein the trigger descriptor register includes a clock field for selecting between two or more units of time.

5) The system of claim 1 further comprising a priority encoder configured manage the priority of bus operations, if a plurality of triggers have been selected.

6) The system of claim 2, wherein the event select field and the holdoff field are utilized for chaining two or more triggers together.

7) The system of claim 1, wherein software can re-enable a trigger descriptor register.

8) The system of claim 1, wherein the trigger descriptor register may further include one or more of the following fields:
a condition field, identifying various conditions within the system;
a bus enable field indicating whether the bus operation associated with the trigger descriptor register is enabled; or
a read/write field indicating whether the bus operation associated with the trigger descriptor register is a read or a write operation.

9) The system of claim 1, wherein the trigger itself is a bus operation.

10) The system of claim 1, wherein the trigger is a subset of two or more triggers.

11) A method for implementing bus operations with precise timing, the method comprising:
providing a trigger descriptor including:
a bus definition field further including data and address fields;
an event select field configured to select a trigger for the bus operation;
selecting a trigger for triggering the bus operation based on the event select field;
performing the bus operation based on the address and data fields.

12) The method of claim 11 further comprising the steps of:
deriving a time period from one or more of:
a holdoff field; or
an external timer; and
counting based on the time period,
wherein the trigger descriptor further includes the holdoff field.

13) The method of claim 11 further comprising selecting between two or more units of time based on a clock field in the trigger descriptor.

14) The method of claim 11 further comprising managing the priority of bus operations, if a plurality of triggers have been selected.

15) The method of claim 12 further comprising chaining two or more triggers together by utilizing the event select field and the holdoff field.

16) The method of claim 11 further comprising re-enabling a trigger descriptor by software.

17) The method of claim 11, wherein the trigger may further include one or more of the following fields:
a condition field, identifying various conditions related to the hardware;
a bus enable field indicating whether the bus operation associated with the trigger descriptor is enabled; or
a read/write field indicating whether the bus operation associated with the trigger descriptor is a read or a write operation.

18) The method of claim 11, wherein the trigger itself is a bus operation.

19) The method of claim 11, wherein the trigger is a subset of two or more triggers.
